(19) United States
(12) Patent Application Publication
(10) Pub. No.: US 2009/0304018 A1
(43) Pub. Date: Dec. 10, 2009

(54) Method, System Bandwidth Manager for Preventing Overbooking of Resources in a Data Network

(75) Inventors: Anders Torger, Lulea (SE); Joakim Norrgård, Lulea (SE); Ulf Bodin, Lulea (SE)

Correspondence Address: SLATER & MATSIL, L.L.P., 17950 PRESTON RD, SUITE 1000, DALLAS, TX, 75252-5793, US

(73) Assignee: OPERAX AB, Lulea (SE)

(21) Appl. No.: 11/919,397

(22) PCT Filed: Jul. 1, 2005
(86) PCT No.: PCT/SE2005/001060

§ 371 Date: Oct. 26, 2007

Related U.S. Application Data
(60) Provisional application No. 60/677,347, filed on May 4, 2005.

(51) Int. Cl. H04L 12/28

(52) U.S. Cl. 370/431

(57) ABSTRACT

A Bandwidth Manager, BM, entity connectable to a Bandwidth Manager system (300) adapted to serve clients having knowledge about performed resource reservations and including a plurality of Bandwidth Manager, BM, entities hierarchically connected in multiple levels, wherein one or more BMs is/are located at each level. The BM entity includes elements for synchronizing states of BM entities located at a level higher than the level of the BM entity, wherein at least two BM entities at the higher level are workers.

### FIELD OF THE INVENTION

The present invention relates to a method and arrangements in a data network. In particular, the present invention relates to a Bandwidth Manager (BM) system, a BM and a method that prevent overbooking of network resources in the data network.

### BACKGROUND

A current networking trend is to provide “Internet Protocol (IP) all the way” to wired and wireless units in an IP based data network. Objectives include simplifying the infrastructure, supporting a wide range of applications, and meeting diverse user demands on the communication service. Satisfying these objectives requires scalable and reliable solutions are needed providing service differentiation and dynamic bandwidth management within IP networks.

IP was from the beginning designed to be a general communication solution. IP technology is now recognised to be cheap and appropriate for supporting both traditional data applications and delay-sensitive real-time data applications. To provide expected service for real-time applications, logically (and physically) separate IP networks are used.

Each IP network serves only a subset of sensitive applications (e.g. IP telephony) with quite predictable bandwidth requirements. By limiting the range of applications, the total bandwidth demand can be predicted. This allows for the network to be dimensioned using the same traffic models as are used for vertically optimised networks. The benefit of cheap IP equipment is obtained without requiring support for dynamic service provisioning in the IP technology.

Network operators now aim at cutting the overhead cost of maintaining several parallel networks. One current trend is to simplify the infrastructure by running all kinds of applications, with various network service demands, in the same logical IP network (i.e. next generation multi-service networks). This means that the application heterogeneity in IP networks is increasing.

In the research and standardisation bodies the development of QoS support has progressed from providing signalled solutions for the Internet (somewhat resembling the solutions used in vertical networks) to now recognising that more stateless solutions are favourable.

The scalability problems of solutions using per-flow QoS management in routers have resulted in the differentiated services architecture defined by the IETF. The objective with this architecture is to provide scalable QoS support without requiring per-flow state in routers. The basic idea is that IP packet headers include a small label (known as the DiffServ field) that identifies the treatment (per-hop behaviour) that packets should be given by the routers. Consequently, core routers are configured with a few forwarding classes and the labels are used to map packets into these classes. The architecture relies on packet markers and policing functions at the boundaries of the network to ensure that the intended services are provided.

One advantage of differentiated services is that the model preserves the favourable properties that made the Internet successful; it supports scalable and stateless forwarding over interconnected physical networks of various kinds. The standard model is, however, limited to differentiated forwarding in routers and therefore the challenge lies in providing predictable services to end users.

Qualitative services (relatively better than best-effort services, but depending on where the traffic is sent and on the load incurred by others at the time) can be provided by relying only on DiffServ support in routers and bandwidth management mechanisms for semi-static admission control and service provisioning.

To provide quantitative (minimum expectation) service, resources must be dynamically administrated by bandwidth management mechanisms and involve dynamic admission control to make sure that there are sufficient resources in the network to provide the services committed.

The entity performing dynamic admission control is in this specification called a bandwidth manager (BM). The BM is adapted to keep track of the available network resources and performs admission control on incoming resource reservation requests from clients. Clients to a bandwidth manager are typically call servers emulating the traditional telephony service and various broadband application frameworks providing services such as video on demand, video telephony, and gaming. These clients are commonly referred to as application frameworks (AFs) and the term AF is also used in this specification to denote the clients to the BM.

A reservation request from an application framework to a BM typically include the amount of bandwidth needed, a description of the forwarding quality expected, and endpoint identifiers for the target data stream in the form of IP addresses. Such request may also include additional arguments such as start and stop times for the reservation.

To perform admission control the BM stores a history of previously admitted resource reservations. The BM takes decisions to admit new resource requests based on the total amount of available resources, the amount currently reserved by previously reservations and the amount of resources requested in the new resource request.

The BM should provide accurate resource control both in access domains and in core domains. Accurate resource control requires the BM to control resources at individual contention points in the network. Contention points in a network are those points at which multiple data streams share forwarding capacity. Examples include outgoing network interfaces, tunnel heads in MPLS networks, and VC/CP entrances in ATM networks.

When deployed in large data networks that may include multiple network domains the BM system needs to be distributed for performance, scalability and reliability reasons. This means that BM instances may be distributed on a set of hardware platforms. These instances must communicate to serve AFs with resource reservation services in the different network domains covered by the BM system. Examples are described on how a set of BM instances can be arranged in distributed BM systems. FIG. 1 shows a BM deployment comprising a plurality of AFs 100a-f. The AF 100 a,b are connected to the top level BM 102 a, the AFs 100 c,d are connected to the top level 102b and the AFs 100 e,f are connected to the top level 102c. The top-level BMs are further connected to the sub-network BMs 104a-c. The example shown in FIG. 1 cover bandwidth management in access 106,108,110, backhaul 112, core 116 and interconnect 120 domains. The access network comprises a Customer Premises Equipment (CPE) 108 and an end-terminal 106. The backhaul network 112 and the core network 116 are connected via an IP edge 114 in the same way as the core network 116 and the interconnect network 120 that are connected via the IP edge denoted 118.

BMs (instances) can be scaled in a hierarchical manner as shown in FIG. 1, whereby BMs at each level in the hierarchy reserve resources from lower level BMs. Lower level BMs are responsible for different sub-domains of the network. Such BMs are referred to as sub-network BMs denoted S-BMs. Top-level BMs are responsible for identifying the sub-network that the session crosses and hence the sub-network BMs that must be queried for resources. FIG. 2 illustrates a BM deployment as in FIG. 1 with the difference that the sub network BMs may request resources from another BM in an adjacent peer domain as indicated by the arrows 202 and 204.

In a distributed BM system mechanisms are provided for automatically finding the right BMs across the layers in the hierarchy and between peers. Thereby an AF does not need to understand the underlying network topology. Finding the appropriate BM is achieved by using “source seeking” BMs. Such BMs take requests from initiating BMs and forward them to the BM being responsible for performing the reservation.

For the hierarchical model multiple top-level BMs interact with AFs. Each AF may have a designated top-level BM which provides a high level routing and distribution function, identifying the sub-network hops that the data stream must traverse. Top-level BMs then pass requests to sub-network BMs which are responsible for reserving resources in individual networks.

Because of the topology model and the routing function of the top-level BM, all hops of the reservation, originating access, core, terminating access can be derived from the top-level BM. In any architecture there can be multiple top-level BMs since no single top-level BM needs to understand the state of the reservations of the others.

Below the top-level BM multiple sub-network bandwidth managers are provided which map the reservation requests to the underlying network resources. These BMs take reservation requests from multiple top-level BMs and perform Call Admission Control (CAC) based on the occupancy of the network resources.

The hierarchically distributed BM architecture scales in two dimensions:

Scaling of reservation request load is obtained by deploying multiple top-level BMs. Bandwidth for individual sessions/calls are requested from the top-level BMs, which share aggregate resources in their domain by interacting with lower level BMs for requesting (pre-allocating) bandwidth aggregates.

Scaling to arbitrary large topologies is obtained by deploying several BMs at the bottom layer responsible for different topological sub-domains inside the domain. BMs may be configured to allocate (aggregate) resources with BMs in adjacent (peering) sub-domains an additional dimension of scale is achieved. By combining the hierarchical model with peering as shown in FIG. 2, each top-level BM does not have to interact with each BM of the sub-domains. This effectively results in adding more levels to the hierarchy.

In the peering model the correct “source” BM for a session must be identified as it is responsible for initiating any requests to peer BMs. In order to hide the network topology of the bandwidth management layer to the AF layer, the AF does not need to know where the source BM for each reservation is specifically located. The AF only needs to initiate a request to any BM and the request will be transferred to the source BM via a source seeking BM process, so that a normal process of the request for resources can be started.

In the example system architectures described in the previous section, top-level BMs need to communicate directly or indirectly with other BMs to allocate aggregate bulk resources that can be offered to AFs. Bulk resources may also need to be allocated between the BMs arranged in a hierarchy as shown in FIG. 1 or between peering BMs as shown in FIG. 2. Naturally, the BMs need also to return bulk resources that are not needed in the near future. Note that the chain of BMs involved in allocating bulk resources can include two or more BMs arranged in hierarchy or as peers. A reservation for bulk resources made by a given BM is an amount of resource allocated for an aggregate of reservations maintained by the BM. Such a bulk reservation can be made by a BM in advance to prepare for future reservation request arriving, or immediately as reservations are requested in the BM.

By allocating resources in bulk for aggregates of reservations, top-level BMs can immediately grant reservation requests made by application frameworks. This is attractive since it allows the system to offer short response times for such requests.

Bulk resources can be allocated between BMs for individual contention points, for individual paths through a network domain, or for network domains. Contentions points, paths, and networks can all be represented as objects for which resources can be allocated. Such objects are referred to as resource objects in this specification.

A distributed BM system can implement different resilience strategies. Resilience means protection against failure, the ability to recover from different failure situations.

Standby BM instances may keep up-to-date information on network resources represented as resource objects (hot standbys), or may need to acquire such information when activated (warm standbys). Standby nodes not having BM instances up running are commonly referred to as cold standbys.

Hot standby BMs may maintain reservation states for a backed up worker in addition to the information on network resources being kept hot, or rely on that such information is loaded into the standby at failover. Information on reservation states can be loaded through auditing. E.g. in a hierarchical BM system such as those shown in FIG. 2 and FIG. 1, a hot S-BM standby being activated may audit the top-level BMs to re-establish the reservation states of the S-BM it was backing up. Real time synchronisation is required for hot standbys in order to achieve seamless failover from an active node to a standby node. A worker is an instance that is currently active in serving its clients.

BMs at the same level in a hierarchical BM system can be arranged such that all, or a plurality of BMs are workers. It is advantageous to have a plurality of workers at the same level, since clients may contact any BM of the worker BMs. It is then possible to share the load between the worker BMs and the client may change BMs seamlessly, also for active sessions. All BMs in a set of workers should at any time be capable of serving any other BM at the level above or, when the set of BMs constitutes the top-level, any AF requesting resources. This requires that resource bookings made in these BMs are synchronized in real time to ensure that resources are not overbooked. Overbooking implies that resources related to one request are reserved more than once. A disadvantage is that the real time synchronisation requires continuous connectivity and such a system will therefore fail during connectivity failure.

Therefore, it would be desirable to be able to prevent overbooking in a BM system having at least two BMs at one or more levels arranged as workers without relying on real time synchronisation. If real time synchronisation is avoided the BM system is able to protect against overbooking in failure scenarios including connectivity failure between BMs.

### SUMMARY OF THE PRESENT INVENTION

Thus, the object of the present invention is to provide means that is able to prevent overbooking even during connectivity failure between BMs.

The objective of the present invention is achieved by the system of claim 1, by the method of claim 11, by the computer program product of claims 20 and 21 and by the system of claim 22.

Preferred embodiments are defined by the dependent claims.

According to a first aspect, the present invention relates to a Bandwidth Manager, BM, entity connectable to a Bandwidth Manager system adapted to serve clients having knowledge about performed resource reservations and comprising a plurality of Bandwidth Manager entities hierarchically connected in multiple levels, wherein one or more BMs is/are located at each level. The BM entity comprising means for synchronising states of BM entities located at a level higher than the level of said BM entity, wherein at least two BM entities at the higher level are workers makes it possible to prevent overbooking even during connectivity failure between BMs.

According to a second aspect, the present invention relates to a method in a Bandwidth manager, BM, entity connectable to a Bandwidth Manager, BM, System (300) adapted to serve clients having knowledge about performed resource reservations and comprising a plurality of Bandwidth Manager, BM, entities hierarchically connected in multiple levels, wherein one or more BMs is/are located at each level. The method comprising the step of synchronising states of BM entities located at a level higher than the level of said BM entity, wherein at least two BM entities at the higher level are workers, makes it possible to prevent overbooking even during connectivity failure between BMs.

According to a third aspect, the present invention relates to a Bandwidth Manager system (300) adapted to serve clients having knowledge about performed resource reservations and comprising a plurality of Bandwidth Manager, BM, entities hierarchically connected in multiple levels, wherein one or more BMs is/are located at each level. The BM system comprising means for synchronising on behalf of upper BMs located on a higher lever, wherein at least two BM entities at the higher level are workers, makes it possible to prevent overbooking even during connectivity failure between BMs.

According to fourth aspect, the present invention relates to a computer program product directly loadable into the internal memory of a computer within a router or server in a data network, comprising the software code portions for performing the steps of the method.

According to fifth aspect, the present invention relates to a computer program product stored on a computer usable medium, comprising readable program for causing a computer, within a router or server in a data network, to control an execution of the steps of the method.

Synchronising states transferred in real time between BMs consumes forwarding resources, processing capacity and memory in BM nodes. Hence, an advantage of the present invention is that the present invention enables a stronger solution for resilience at lower cost compared to one that requires state synchronisation in real time between BMs at the same level.

A further advantage of the present invention is that the problem of recovering bandwidth after failure is solved by the introduction of reservation offsets, which allows most bandwidth for which reservation states are lost to be immediately reused without risking bandwidth overbooking. Avoiding bandwidth overbooking is essential since guarantees or assurances on forwarding quality otherwise will be violated.

### DRAWINGS

FIG. 1 shows a hierarchic bandwidth manager deployment.

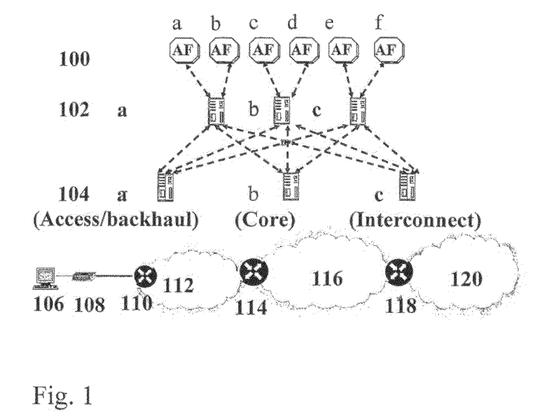

FIG. 2 shows a hierarchic bandwidth manager deployment with peering.

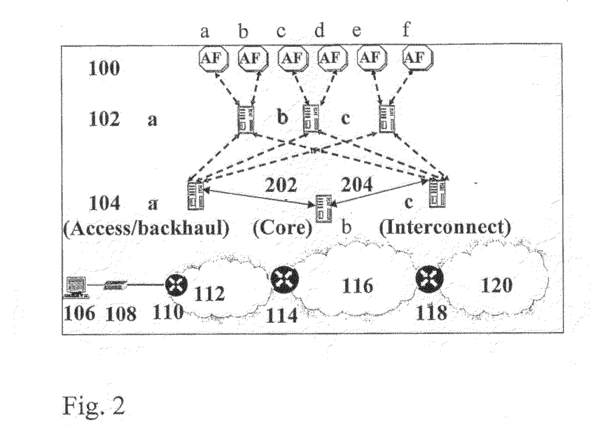

FIG. 3 discloses synchronisation points for all BM worker resilience according to the present invention.

### DETAILED DESCRIPTION OF THE PRESENT INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather these embodiments are provided so that this disclosure will be thorough and complete, and will fully convey the scope of the invention to those skilled in the art. In the drawings, like numbers refer to like elements.

The present invention according to the first aspect relates to a Bandwidth manager (BM) entity adapted to be a part of a BM system comprising a plurality of BMs hierarchically connected in multiple levels, wherein one or more BMs is/are located at each level. A BM is typically realised by software means and may be implemented in conventional routers and servers in a conventional data network 100 comprising interconnected routers 110 and servers.

An example of such a conventional network is a multi-technology network where an operator provides an IP/MPLS backbone and several access networks based on various switched link layer technologies e.g., including an access network based on ATM switching, another access network based on Ethernet switching and a third based on WLAN technologies. Moreover, the network may comprise interconnectable routers, servers and other network elements known by a man skilled in the art.

In this application, a data network is defined as a switched network forwarding data units between network interfaces of network nodes using identifiers associated with the target circuit being setup through the network e.g., as in Asynchronous Transfer Mode (ATM networks and in Multiprotocol Label Switching (MPLS) networks, or a datagram network forwarding data units between network interfaces of network nodes using global addresses enabling local next-hop decisions made by each node e.g., as in Internet Protocol (IP) networks. The data units may be of fixed size e.g., ATM cells or of variable size e.g., IP packets using their destination addresses for datagram forwarding or using MPLS tags for switching.

The invention according to the present invention provides means for preventing overbooking wherein the synchronisation between BMs needed for resilience at levels where several BMs are workers is not required to be performed in real time.

Real time synchronisation is not necessary since the present invention utilizes that the clients have knowledge about resource reservations previously performed. Based on that knowledge, the clients are able to send messages associated with previous performed reservations. The messages create offsets that are used for managing a synchronisation procedure according to embodiments of the present invention, which is further described below. This synchronisation procedure is not required to be performed in real time.

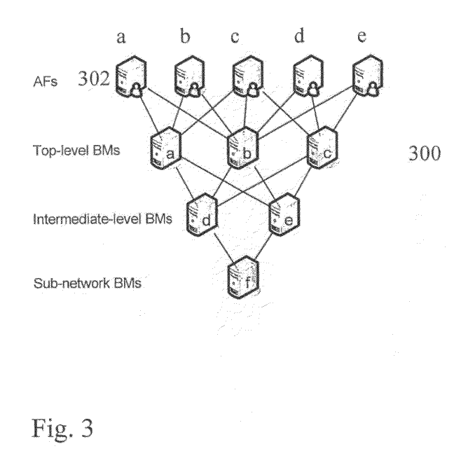

The synchronisation procedure is performed by BMs at a level directly below the BM worker level, or several levels below such worker level. FIG. 3 illustrates a BM system 300 comprising BMs managing resources for AFs 302a-e. The AFs are connected to top-level BMs a-c that are further connected to intermediate-level BMs d-e. The intermediate-level BMs d-e are further connected to a sub-network BM f. As illustrated, in FIG. 3, the intermediate-level BM “d” can synchronise states for top-level BMs “a”, “b” and “c” given that all of the intermediate-level BMs “d” and “e” are not workers. Sub-network BM “f” can synchronise states for all other BMs. A BM capable of synchronising on behalf of upper BMs is referred to as a state synchronisation BM (SS-BM). SS-BMs cannot be WR-BMs and are thus instead typically backed up by a standby BM.

The present invention is based on that (1) all reservations have a limited lifetime. The life time of a reservation is referred to as the refresh interval. Also, the invention presumes that (2) AFs and BMs (i.e. top-level and intermediate level BMs) provide complete reservation information in insert and update messages. The first message issued when requesting a reservation is referred to as an insert, while messages extending the lifetime of an existing reservation are referred to as updates. According to an embodiment of the present invention, a remove message is introduced. The remove message makes it possible to effectively terminate reservations before they are automatically aborted as their life times out. The remove and update messages create the above mentioned offsets.

The essential parts of the complete reservation information are typically the amount of requested resources, the endpoints of the reservation, and for updates and removes, a reservation ID possibly accompanied with an authentication token. An authentication token is a type of code used to guarantee that a message is sent from an entitled unit. The code may be connected to a part of the message. The authentication token may be needed when AFs or upper level BMs cannot be trusted. Additional information may also be included. In general, the concept requires that the same information given in inserts that creates any form of state in the BM system must be provided also in updates and removes.

The reservation ID is typically created by a BM receiving an insert message. The ID is then sent back to the entity issuing the insert as part of an acknowledgement granting the reservation request. Replies to rejected reservation requests do not need to include a reservation ID.

As mentioned above, AFs, top-level BMs and intermediate level BMs may request resources from a level at which a plurality of BMs are workers. In this specification it is hereafter referred to such requesters as requesting entities (REs) and BMs at a level where several BMs are workers as worker resilient BMs (WR-BMs).

Based on (1) and (2), enough state synchronisation to prevent overbooking of resources can be obtained through what is herein referred to as reservation offsets, as mentioned above. A reservation offset is directly associated with a resource object. The BM according to embodiments of the present invention is adapted to manage such reservation offsets.

A negative reservation offset keeps track of resource reservations that have expired in a BM for the RE that established the reservation but may be booked in another BM (i.e. the other BM may have taken over the reservation). A positive reservation offset is the amount of resources that is returned to or updated in a WR-BM but that is previously booked in another WR-BM at the same level, i.e. the WR-BM getting the resource reservations removed or updated has no reservation state associated with them, since the insert messages that created the reservations was sent to another WR-BM.

When one or more WR-BMs fail or when a RE change the WR-BM to interact with, REs may send updates and removes to another WR-BM but the one at which their current reservations are inserted, i.e. the failed WR-BM. Unknown updates and removes are identified by that the reservation ID of these messages are unknown by the WR-BM receiving them.

The reservation offsets is according to embodiments of the present invention created by using the messages remove and update. A remove gives a positive offset that may be used for a new reservation and an update gives a positive offset plus a new reservation. That implies that an update is interpreted as a remove plus an insert. Hence, a WR-BM receiving unknown updates or removes accepts them and creates positive reservation offsets for the involved resource objects. Update messages for reservations not previously inserted in the WR-BM receiving those results further in that bandwidth is allocated for the involved resource objects. Allocating this bandwidth is always possible since positive offsets effectively increase the amount of resources available for booking. This means that resources returned through removes immediately becomes available for new reservations requested using insert messages.

As indicated above, negative reservation offsets are created when reservations have expired in a BM for the RE that established the reservation but may be booked in another BM. Negative offsets hence keep track of resources retained through timer expiration, while positive offsets keep track of resources returned through updates or removes. Note that expired bandwidth in a BM is no longer available. Hence, even if a BM for which a booking expires in a lower-level BM remains operational, the expired bandwidth cannot be used.

Reservations offsets, both positive and negative, are reported downwards stepwise in the BM hierarchy i.e. level by level until they reach the SS-BM responsible of synchronizing states for the WR-BMs that reserve the resources of the resource object for which the offset is maintained. Such reports may be issued immediately as the event causing the reservation offset to be created occurs, after a period allowing multiple offsets to be aggregated into single reports, or periodically to allow for both aggregation and controlled signalling rates between BM levels. In all cases reports need to be sent within the refresh interval of the reservations made with the next lower BM.

Before being reported downwards in the BM hierarchy, negative and positive reservation offsets may even out each other completely or partly. E.g., considering the structure of BMs shown in FIG. 3, say that a top-level WR-BM sends a remove message to an intermediate-level WR-BM. This intermediate-level WR-BM then creates a positive offset for a resource object. However, before this WR-BM reports the positive offset downwards to the sub-network SS-BM another reservation with the same resource object expires and a negative reservation offset is created. If these offsets are equal in size they will even each other out. Otherwise only the difference between them will be kept by the intermediate WR-BM as a negative or positive reservation offset, which eventually may be reported downwards to the SS-BM.

Each BM receiving reservation offset reports acknowledges them upwards and creates their own reservation offsets. When the reservation offsets are reported all the way down to an SS-BM they only exist in this SS-BM. Note that intermediate BMs between the up most WR-BM level and the SS-BM may or may not themselves be WR-BMs.

In SS-BMs reservation offsets must be kept until all active reservations made by the REs are guaranteed to have expired, been updated, or removed. This means that reservation offsets in SS-BMs must have refresh intervals (lifetimes) long enough to provide this guarantee. The value of a refresh interval for reservation offsets in an SS-BM depends on all the refresh intervals of reservations made by AFs and all BMs above the SS-BM in the hierarchy.

Maintaining negative and positive reservations offsets allows the BM system to use some of the resources allocated by failed or abandoned WR-BMs that otherwise would have been locked by such WR-BMs. I.e. returned resources may be used immediately by new reservations and resources having updated reservations do not have to reserve new resources but may automatically use the already reserved resources. Since the WR-BM may pre-allocate resources the complete amount of resources allocated by such WR-BMs may however not be available until reservation offsets times out in SS-BMs. This means that all negative offsets cannot be used by positive offsets when a WR-BM has pre-allocated resources. Remaining negative reservation offsets becomes available only after such offset has expired. I.e., positive and negative offsets are reported to a SS-BM and a WR-BM may reserve more resources compared to the reserved resources of its clients, which implies that the negative and the positive offsets are not equal. In this case, the remaining offsets are negative corresponding to the resources reserved by the WR-BM in excess to the resources reserved by the clients. Thus, these resources become available first when the remaining negative offset has expired. Note that only negative offsets may remain upon expiration. Positive offsets will then always have been cancelled by equally sized or larger negative offsets. Upon expiration in an SS-BM, negative offsets appear as resources, e.g. bandwidth, returned to the SS-BM.

In the drawings and specification, there have been disclosed typical preferred embodiments of the invention and, although specific terms are employed, they are used in a generic and descriptive sense only and not for purposes of limitation, the scope of the invention being set forth in the following claims.

1. A Bandwidth Manager, BM, entity connectable to a Bandwidth Manager system (300) adapted to serve clients having knowledge about performed resource reservations and comprising a plurality of Bandwidth Manager, BM, entities hierarchically connected in multiple levels, wherein one or more BMs is/are located at each level, characterised in that the BM entity comprises means for synchronising states of BM entities located at a level higher than the level of said BM entity, wherein at least two BM entities at the higher level are workers.

2. The Bandwidth Manager BM entity according to claim 1, characterised in that the BM entity is arranged to handle negative reservation offsets indicative of expired resource reservations in a BM entities wherein the reservation may be booked in another BM entity.

3. The Bandwidth Manager BM entity according to claim 1, characterised in that the BM entity is arranged to handle positive reservation offsets indicative of the amount of resources that is returned to or updated in a worker BM but that is previously booked in another worker BM at the same level.

4. The Bandwidth Manager BM entity according to claim 3, characterised in that the BM entity is arranged to handle a remove message terminating a reservation before it is automatically aborted as its life times out to create the positive reservation offset.

5. The Bandwidth Manager BM entity according to claim 3, characterised in that the BM entity is arranged to handle an update message extending the lifetime of an existing reservation by creating a positive reservation offset and establish a new reservation state.

6. The Bandwidth Manager BM entity according to claim 2, characterised in that the BM entity is arranged to report the reservation offsets downwards stepwise in the hierarchy of BMs.

7. The Bandwidth Manager BM entity according to claim 6, characterised in that the BM entity is arranged to issue the report immediately as the event causing the reservation offset to be created occurs, issue the report after a period allowing multiple offsets to be aggregated into single reports, or issue the report periodically.

8. The Bandwidth Manager BM entity according to claim 7, characterised in that the BM entity is arranged to send the report within the refresh interval of the reservations made with the next lower BM entity.

9. The Bandwidth Manager BM entity according to claim 7, characterised in that the BM entity is arranged to receive reservation offset reports, to acknowledge them upwards and to create their own reservation offsets.

10. The Bandwidth manager, BM, according to claim 1, characterised in that the BM entity is implemented by computer program product.

11. A method in a Bandwidth manager, BM, entity connectable to a Bandwidth Manager, BM, System (300) adapted to serve clients having knowledge about performed resource reservations and comprising a plurality of Bandwidth Manager, BM, entities hierarchically connected in multiple levels, wherein one or more BMs is/are located at each level, characterised in that the method comprises the step of:
synchronising states of BM entities located at a level higher than the level of said BM entity, wherein at least two BM entities at the higher level are workers.

12. The method according to claim 11, characterised in that the method comprises the further step of:
creating negative reservation offsets indicative of expired resource reservations in a BM entities wherein the reservation may be booked in another BM entity.

13. The method according to claim 11, characterised in that the method comprises the further step of:
creating positive reservation offsets indicative of the amount of resources that is returned to or updated in a worker BM but that is previously booked in another worker BM at the same level.

14. The method according to claim 13, characterised in that the method comprises the further step of:
handling a remove message terminating a reservation before it is automatically aborted as its life times out to create the positive reservation offset.

15. The method according to claim 13, characterised in that the method comprises the further step of:
handling an update message extending the lifetime of an existing reservation by creating a positive reservation offset and establish a new reservation state.

16. The method according to claim 12, characterised in that the method further comprises the step of:
reporting the reservation offsets downwards stepwise in the hierarchy of BMs.

17. The method according to claim 16, characterised in that the method comprises the further step of:
issuing the report immediately as the event causing the reservation offset to be created occurs, or
issuing the report after a period allowing multiple offsets to be aggregated into single reports, or
issuing the report periodically.

18. The method according to claim 17, characterised in that it comprises the further step of:
sending the report within the refresh interval of the reservations made with the next lower BM entity.

19. The method according to claim 17, characterised in that it comprises the further step of:
receiving reservation offset reports, to acknowledge them upwards and to create their own reservation offsets.

20. A computer program product directly loadable into the internal memory of a computer within a router or server in a data network, comprising the software code portions for performing the steps of claim 11.

21. A computer program product stored on a computer usable medium, comprising readable program for causing a computer, within a router or server in a data network, to control an execution of the steps of claim 11.

22. A Bandwidth Manager system (300) adapted to serve clients having knowledge about performed resource reservations and comprising a plurality of Bandwidth Manager, BM, entities hierarchically connected in multiple levels, wherein one or more BMs is/are located at each level, characterised in that the BM system comprises means for synchronising on behalf of upper BMs located on a higher lever, wherein at least two BM entities at the higher level are workers.

23. The Bandwidth Manager system according to claim 22, characterised in that the BM system is arranged to handle negative reservation offsets indicative of expired resource reservations in a BM entities wherein the reservation may be booked in another BM entity.

24. The Bandwidth Manager system according to claim 22, characterised in that the BM system is arranged to handle positive reservation offsets indicative of the amount of resources that is returned to or updated in a worker BM but that is previously booked in another worker BM at the same level.

25. The Bandwidth Manager system according to claim 24, characterised in that the BM system is arranged to handle a remove message terminating a reservation before it is automatically aborted as its life times out to create the positive reservation offset.

26. The Bandwidth Manager system according to claim 24, characterised in that the BM system is arranged to handle an update message extending the lifetime of an existing reservation by creating a positive reservation offset and establish a new reservation state.

27. The Bandwidth Manager system according to claim 23, characterised in that the BM system is arranged to report the reservation offsets downwards stepwise in the hierarchy of BMs.

28. The Bandwidth Manager system according to claim 27, characterised in that the BM system is arranged to issue the report immediately as the event causing the reservation offset to be created occurs, issue the report after a period allowing multiple offsets to be aggregated into single reports, or issue the report periodically.

29. The Bandwidth Manager BM system according to claim 28, characterised in that the BM system is arranged to send the report within the refresh interval of the reservations made with the next lower BM entity.

30. The Bandwidth Manager system according to claim 28, characterised in that the BM system is arranged to receive reservation offset reports, to acknowledge them upwards and to create their own reservation offsets.
